(19) United States
(12) Patent Application Publication
(10) Pub. No.: US 2002/0154747 A1
(43) Pub. Date: Oct. 24, 2002

(54) Systems and methods for visual access to voicemail

(76) Inventor: Yuri Shtivelman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/842,099

(22) Filed: Apr. 24, 2001

(51) Int. Cl. H04M 1/64; H04M 1/56

(52) U.S. Cl. 379/88.19; 379/142.01

(57) ABSTRACT

Systems and methods for providing visual information to a telephone user regarding voicemail associated with a telephone number. The method includes providing a telephone comprising a display and organizing information relating to messages in the voicemail, wherein the information comprises the number of messages, a primary phone number from which each message was received, and a name associated with each primary phone number. Finally, the information is displayed on the display. Additional information may include at least one alternative phone number associated with each primary phone number and a length of time for each message.

### BACKGROUND OF THE INVENTION

1. Field of the Invention

The present invention relates to access to voicemail and telephone systems, and more particularly, to a visual access to voicemail systems in wireless telephones.

2. Description of the Prior Art

In modern telephone systems, the voicemail feature is a great convenience and help to users. Users may have the telephone voicemail as a feature of the public carrier supplying their home phone system, as a feature of their office PBX, or as part of their mobile phone system. Voicemail is particularly important in mobile phone systems since, users often, even while carrying the telephone, may not be able to receive calls because of bad reception due to the topology of an area, network overload, interference with any building, and many other possible causes.

In today's society, immediate telephone communication has become important to most telephone users. This is particularly true with respect to mobile telephone users whose phone calls may not always get through. Additionally, mobile telephone users, as indicated by the very fact of subscribing to a mobile phone service, attach great importance to always being in contact by telephone. People are generally busy with business matters, family matters, and/or scholl matters, etc. Accordingly, people are generally juggling many activities at once and are generally attempting to communicate with numerous other people. It is often difficult to reach these other people for the same reasons—they are likewise busy with various matters. Therefore, people often need to leave messages and obviously, certain matters are more urgent than others so that people often need to speak more urgently with certain people. Thus, it is important to many users that they know as soon as possible whether, and from whom, they have received voicemail.

Unfortunately, today's telephone voicemail systems typically supply limited information about received voicemail messages. Today's voicemail systems typically, if one is lucky, merely indicate the number of messages contained therein. Accordingly, it makes it difficult for telephone users to make informed decisions about which voicemails have the highest priority for listening and responding thereto.

### SUMMARY OF THE INVENTION

The present invention provides novel systems and methods for providing visual information to a telephone user regarding voicemail associated with a telephone number. The method includes providing a telephone comprising a display and organizing information relating to messages in the voicemail, wherein the information comprises the number of messages, a primary phone number from which each message was received, and a name associated with each primary phone number. Finally, the information is displayed on the display.

In accordance with one aspect of the present invention, the information further comprises at least one of at least one alternative phone number associated with each primary phone number and a length of time for each message.

In accordance with a further aspect of the present invention, at least some of the information is provided by one of caller identification (CALLER-ID), ANI or voice prompt and complemented from a lookup directory.

In accordance with yet another aspect of the present invention, the lookup directory is contained on a voicemail server.

In accordance with a further aspect of the present invention, the lookup directory is contained on a wireless application protocol server.

In accordance with another aspect of the present invention, the lookup directory is contained on the telephone.

In accordance with yet a further aspect of the present invention, the method further includes selecting a message to which to listen based upon the information.

In accordance with yet another aspect of the present invention, the method includes returning a phone call based upon the information.

In accordance with a further aspect of the present invention, the phone calls returned by pressing a single button on the telephone.

The present invention also provides a system for providing visual information to a telephone user regarding voicemail and a telephone number. The system includes a telephone network, a telephone comprising a display and that is in communication with the telephone network, a voicemail system and a visual voicemail manager. The visual voicemail manager is configured to organize information relating to messages in the voicemail system wherein the information comprises the number of messages, a primary phone number from which each message was received and a name associated with each primary phone number. The visual voicemail manager is also configured to display the information on the display.

Thus, the present invention provides systems and methods for providing visual access to a voicemail system, thus allowing the user to prioritize which message(s) to listen to and/or respond to based upon information provided by the visual voicemail system. The user may not only review the status of their messages, but may also save time and effort associated with listening to each message in a long list of messages in search of a particularly important message for which they have been waiting.

Other features and advantages of the present invention will be understood upon reading and understanding the detailed description of the preferred exemplary embodiments, found hereinbelow in conjunction with reference to the drawings in which like numerals represent like elements.

### BRIEF DESCRIPTION OF THE DRAWINGS

FIG. 1 is a schematic illustration of a voicemail system in accordance with the present invention;

FIG. 2a is an elevational view of an example of a display for a telephone; and

FIG. 2b is an elevational view of an example of a display in accordance with the present invention for a telephone.

### DETAILED DESCRIPTION OF PREFERRED EXEMPLARY EMBODIMENTS

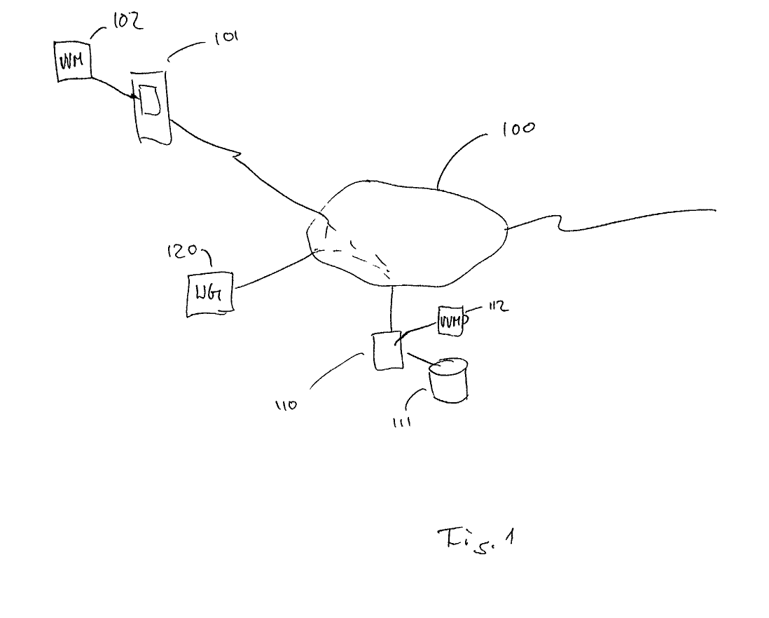

FIG. 1 schematically illustrates an embodiment of the present invention, specifically, topology for a wireless phone system 100 (network cloud) with a wireless application protocol (WAP) phone 101 connected thereto and a special voicemail software instance visual voicemail (VVM) 102. Also shown is a WAP gateway 120 that in some cases may be necessary for the present invention and in other cases may not, and a voicemail server 110 with attached mass storage 111 containing the voicemails.

Those skilled in the art will understand that WAP is not a requirement, but instead merely a convenience, to implement the present invention. Other standards known, or yet to be defined, such as micro browsers or even proprietary architectures, may be used to achieve the same. Other technologies may have a different portioning between the client and the server. In some cases, the client hardware may be merely a terminal, and the application VVM 102, as described above, may run exclusively on the server, somewhere in the network. Whereas in other cases, just the opposite may happen, and no auxiliary server, as described above (server WAP gateway 120) may be required.

Special voicemail software instance 102 is a visual voicemail (VVM) manager that is compatible with any of the numerous voicemail systems currently known in the art. While typically it may reside in mobile handset 101, a WAP phone in this example, in other cases, however, VVM 102 may be loaded on demand from a server, using a shortcut or other link, as allowed by current telephone system technology and able to be implemented by one skilled in the art. The VVM 102 has two-way communication capabilities, with either the VM server 110 directly, or in some cases via WAP gateway 120, as described herein below.

Depending upon the architecture of the software and the telephone system, the WAP gateway 120 may be a required element for the phone 101 to connect to the server 110. In other cases, for example, a proprietary network, such a gateway may not be required.

Also, within voicemail server 110 there is preferably, in addition to the software normally residing in such a server, a visual voicemail presenter (VVMP) software instance 112.

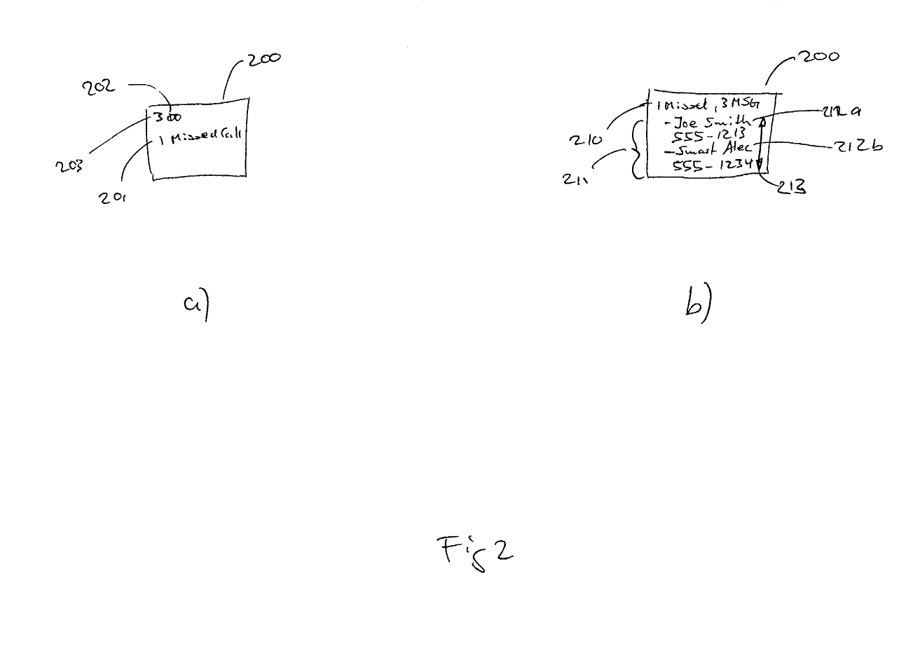

FIG. 2a illustrates a screen, for example a liquid crystal display (LCD), as is typically available on mobile and other types of phones today. Screen 200 displays a message 201 showing, for example, one missed call (i.e., a call that the telephone receives but the user does not answer, as differentiated from a call that the telephone cannot receive, as discussed in the background section of this disclosure). Screen 200 also contains indicator 202 showing the presence of voicemail. In some cases a numeric count 203 may show the number of voicemail messages currently stored. However, these messages and indicators do not make it possible for the user to know who left the voicemails, the telephone numbers of callers, the length of the messages, or any other particulars of each message. Hence it is impossible for the user to prioritize responses without first listening to all the messages.

FIG. 2b illustrates a display as presented by the VVM 102 on a phone screen 200. Header line 210 illustrates a message status summary of, for example, one missed call and three voicemail messages. A list 211 comprises all the entries, each entry representing one voicemail message. The list 211 may be scrolled using scroll bar 213. Each entry, such as 212a, 212b, etc., may contain information such as a telephone number of the caller, derived either by caller-ID, ANI, or voice prompt and complemented from a lookup directory (not shown) that may be on either the voicemail server 110 or the WAP gateway 120, the telephone itself, or any other server. The information may also include the caller's name (which may be a person or organization, for example) and other optional information such as at least one alternate phone number for the caller (or an alternate phone number associated with the first telephone number), the length of the message (for example, a very short message may be unusable or insignificant), and other pertinent information about each voicemail message. In some cases this information may also be extracted from a PDA database that may reside on the WAP phone (not shown).

By viewing the list of messages 211, the user may now decide which message to respond to first, select that message, and, for example, play the message by pressing a button while highlighting the title of the message, or may initiate a return phone call by pressing a button on the telephone while highlighting the caller's phone number. It is an important aspect of the present invention that the user may not only view the status of messages, but may also save the time and effort of listening to each message in a long list of messages, in search of a particularly important message for which he's been waiting. It is also an important aspect of the present invention that the VVM 102, due its interactive nature, may have numerous additional features, including but not limited to, for example, permitting a user to delete a voicemail unheard, copying or forwarding a message to other people, managing lists or groups for distribution of messages, etc.

The present invention is ideally suited for mobile telephone service providers as well as traditional telephone service providers for selling to their clients as an additional service.

Although the present invention has been described with reference to specific exemplary embodiments, it will be appreciated that it is intended to cover all modifications and equivalents within the scope of the appended claims.

What is claimed is:

1. A method of providing visual information to a telephone user regarding voicemail associated with a telephone number, the method comprising:
a. providing a telephone comprising a display;
b. organizing information relating to messages in the voicemail, the information comprising the number of messages, a primary phone number from which each message was received and a name associated with each primary phone number; and
c. displaying the information on the display.

2. The method of claim 1 wherein the information further comprises at least one of at least one alternative phone number associated with each primary phone number and a length of time for each message.

3. The method of claim 1 wherein at least some of the information is provided by one of caller identification (caller-ID), ANI or voice prompt and complemented from a look-up directory.

4. The method of claim 3 wherein the look-up directory is contained on a voicemail server.

5. The method of claim 3 wherein the look-up directory is contained on a server coupled to the voicemail.

6. The method of claim 3 wherein the look-up directory is contained on the telephone.

7. The method of claim 1 further comprising selecting a message to which to listen based upon the information.

8. The method of claim 1 further comprising returning a phone call based upon the information.

9. The method of claim 8 wherein the phonecall is returned by depressing a single button on the telephone.

10. A system for providing visual information to a telephone user regarding voicemail at a telephone number, the system comprising:
a. a telephone network;
b. a telephone comprising a display and in communication with the telephone network;
c. a voicemail system; and
d. a visual voicemail manager configured to organize information relating to messages in the voice mail system, the information comprising the number of messages, a primary phone number from which each message was received and a name associated with each primary phone number, and to display the information on the display.

11. The system of claim 10 wherein the information further comprises at least one of at least one alternative phone number associated with each primary phone number and a length of time for each message.

12. The system of claim 10 further comprising a look-up directory on the voicemail system.

13. A method of doing business by providing visual information to a telephone user regarding voicemail associated with the telephone user, the method comprising:
a. selling at least telephone service to the telephone user
b. providing a telephone comprising a display;
c. organizing information relating to messages in the voicemail, the information comprising the number of messages, a primary phone number from which each message was received and a name associated with each primary phone number; and
d. displaying the information on the display.

14. The method of claim 13 wherein the information further comprises at least one of at least one alternative phone number associated with each primary phone number and a length of time for each message.

15. The method of claim 13 wherein at least some of the information is provided by one of caller identification (caller-ID), ANI or voice prompt and complemented from a look-up directory.

16. The method of claim 15 wherein the look-up directory is contained on a voicemail server.

17. The method of claim 15 wherein the look-up directory is contained on a server coupled to the voicemail.

18. The method of claim 15 wherein the look-up directory is contained on the telephone.

19. The method of claim 13 further comprising selecting a message to which to listen based upon the information.

20. The method of claim 13 further comprising returning a phone call based upon the information.

21. The method of claim 20 wherein the phonecall is returned by depressing a single button on the telephone.
